(19) United States
(12) Patent Application Publication
(10) Pub. No.: US 2007/0250329 A1
(43) Pub. Date: Oct. 25, 2007

(54) GHG emission credit generation and utilization system

(75) Inventors: Randall Ray Richards, Chillicothe, IL (US); James Edward Chapman, Washington, IL (US); Noel Joy Rytter, Dunlap, IL (US); Morton Herman Sill JR., Chillicothe, IL (US); Stephen John Pierz, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/392,569

(22) Filed: Mar. 30, 2006

(51) Int. Cl. G06Q 10/00; G06Q 30/00

(52) U.S. Cl. 705/1

(57) ABSTRACT

A method for generating and utilizing greenhouse gas credits includes collecting a first greenhouse gas and converting the first greenhouse gas to a second greenhouse gas to produce a conversion product, wherein the second greenhouse gas has a global warming potential less than a global warming potential associated with the first greenhouse gas. The method also includes determining a global warming potential reduction associated with the conversion. The method further includes determining a quantity of greenhouse gas credits associated with the conversion based on the global warming potential reduction. The method also includes marketing one or more of the conversion product and the greenhouse gas credits associated with the conversion.

### TECHNICAL FIELD

The present disclosure relates generally to greenhouse gas (GHG) emission reduction credits and, more particularly, to a GHG emission reduction credit generation and utilization system.

### BACKGROUND

The market for greenhouse gas (GHG) emission reduction credits is becoming increasingly active, particularly in countries bound by the provisions of the Kyoto Protocol. According to the Kyoto Protocol, each member country must reduce its overall balance of carbon dioxide equivalent (CO₂e) to meet a target GHG emission limit. The emission limit has been established for each country by a governing body that is empowered to issue fines or other economic penalties for member countries that exceed their prescribed target limit. To meet these emission limits, some governments of the member countries have enacted legislation that imposes GHG emission restrictions on industrial and commercial facilities that operate within the country. The government may penalize companies whose facilities do not meet the restrictions. These penalties may include, for example, fines, work stoppages, and/or restrictions on the eligibility to qualify to bid on government contracts. Thus, the economic incentives for companies to comply with GHG emission restrictions may be significant.

Companies may reduce their CO₂e emissions in a variety of ways. For example, companies may reduce emissions through the performance of GHG emission reduction activities, such as the development and implementation of cleaner technologies (i.e., technologies that reduce GHG emissions or mitigate the impact of certain GHG by converting them to less harmful GHG). Alternatively, companies may purchase GHG credits from companies that have met the imposed restrictions and have subsequently engaged in emission-credit-generating activities. Alternatively and/or additionally, companies may meet emission restrictions through a combination of emission reduction activities and purchase of GHG credits. As more companies look to purchase GHG credits to meet emission reduction requirements, the demand for the purchase of GHG credits may increase significantly. Thus, a system for efficiently facilitating GHG credit generation and utilization may be required.

At least one method for utilizing GHG credits has been developed. For example, U.S. Patent Publication No. 2004/0039684 (“the '684 publication”) to Sandor describes selling GHG credits through the creation, maintenance, and operation of a GHG credit trading market. The system of the '684 publication includes a registry for storing emission credit information for each trading participant and a trading platform for enabling trades between participants based on the allowance and holding information. The system of the '684 publication may allow one or more participants to buy and sell GHG credits with other participants of the market. The trading platform may also allow participants to observe real-time trading activity.

Although the system of the '684 publication may facilitate the use of GHG credits through the establishment of a trade market for buying and selling the credits, it does not provide an integrated system that generates and markets the GHG credits. As a result, entities that wish to sell original GHG credits using the system of the '684 publication may require a separate GHG credit-generation system.

Additionally, although the system of the '684 publication is configured to establish and operate a GHG credit trading market, it does not collect products associated with a GHG credit-generating activity and market these products to prospective buyers. Consequently, should a GHG credit-generating technology yield one or more commercially valuable products (in addition to the generation of GHG credits), the system of the '684 publication may not be equipped to market or sell these products.

The disclosed GHG credit generation and utilization system, and associated method, is directed toward overcoming one or more of the problems set forth above.

### SUMMARY OF THE INVENTION

In accordance with one aspect, the present disclosure is directed toward a method for generating and utilizing greenhouse gas credits. The method may include collecting a first greenhouse gas and converting the first greenhouse gas to a second greenhouse gas to produce a conversion product, wherein the second greenhouse gas has a global warming potential less than a global warming potential associated with the first greenhouse gas. The method may also include determining a global warming potential reduction associated with the conversion. The method may also include determining a quantity of greenhouse gas credits associated with the conversion based on the global warming potential reduction. The method may further include marketing one or more of the conversion product and the greenhouse gas credits associated with the conversion.

According to another aspect, the present disclosure is directed toward a system for generating and utilizing greenhouse credits. The system may include a greenhouse gas conversion facility and a computer system, in communication with the greenhouse gas conversion facility. The greenhouse gas facility may include a greenhouse gas collection apparatus configured to store a supply of a first greenhouse gas. The facility may also include a greenhouse gas converter, configured to convert the first greenhouse gas to a second greenhouse gas, wherein the second greenhouse gas has a global warming potential less than a global warming potential associated with the first greenhouse gas. The facility may further include a product collection apparatus operatively coupled to the greenhouse gas converter and configured to store a supply of a conversion product. The computer system may be configured to determine a global warming potential reduction associated with the conversion. The computer system may also be configured to determine a quantity of greenhouse gas credits associated with the conversion based on the global warming potential reduction. The computer system may be further configured to market one or more of the conversion product and the greenhouse gas credits associated with the conversion.

In accordance with yet another aspect, the present disclosure is directed toward a computer system. The computer system may include one or more input devices configured to receive data associated with a greenhouse gas conversion facility from one or more sensing devices. The computer system may also include a central processing unit, communicatively coupled to the one or more input devices. The computer system may be configured to determine a global warming potential reduction associated with a greenhouse gas conversion, wherein a first greenhouse gas is converted to a second greenhouse gas, the second greenhouse gas having a global warming potential less than a global warming potential associated with the first greenhouse gas. The computer system may also be configured to determine a quantity of greenhouse gas credits associated with the conversion based on the global warming potential reduction. The computer system may be further configured to monitor an amount of a conversion product produced by the greenhouse gas conversion facility. The computer system may also be configured to market one or more of the conversion product and the greenhouse gas credits associated with the conversion.

### BRIEF DESCRIPTION OF THE DRAWINGS

FIG. 1 illustrates an exemplary disclosed process flow diagram associated with a system for generating and utilizing greenhouse gas credits;

FIG. 2 illustrates an exemplary disclosed computer system associated with the system of FIG. 1; and

FIG. 3 is a flowchart illustration of an exemplary disclosed method operating the system of FIG. 1.

### DETAILED DESCRIPTION

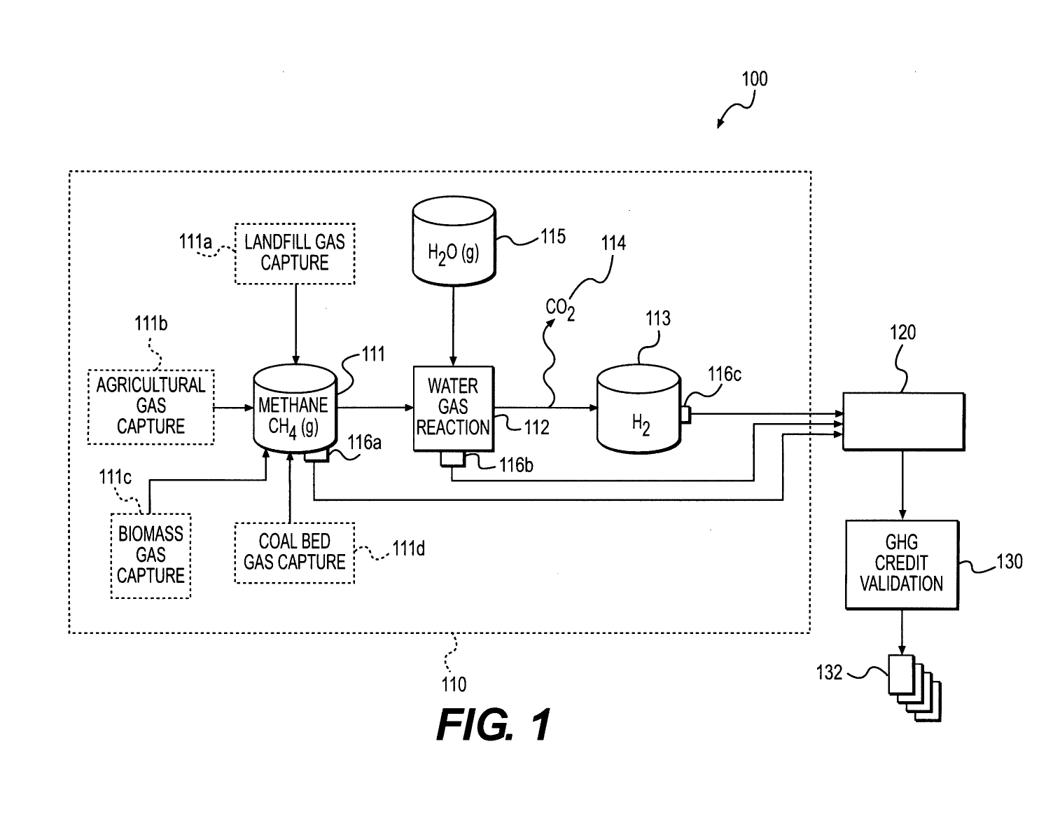

FIG. 1 illustrates an exemplary process flow diagram associated with an exemplary system 100 for generating and utilizing GHG credits consistent with the disclosed embodiments. System 100 may include one or more components and/or subsystems for generating, collecting, marketing, and selling one or more GHG-related products. GHG-related products may include GHG credits generated by the GHG-conversion process and one or more products produced during a GHG-conversion process. System 100 may include, among other things, a GHG conversion facility 110 and a computer system 120. While FIG. 1 illustrates computer system 120 as a separate, stand-alone system with respect to GHG conversion facility 110, it is contemplated that computer system 120 may be integrated as part of GHG conversion facility 110 and/or other subsystems associated with system 100.

GHG conversion facility 110 may include one or more components and/or subsystems configured to reduce a global warming potential (GWP) associated with an emission of GHG from a facility. GWP, as the term is used herein, refers to a measure of the relative impact that a given mass of GHG is estimated to contribute to global warming, as established by the Intergovernmental Panel on Climate Change (IPCC). The GWP of a particular GHG is a measure of comparison of the mass associated with the GHG with the same mass of carbon dioxide (CO₂) (with a defined GWP of 1). The GWP is calculated over a particular time interval, as different gases have different effects on the environment over time. In general, unless otherwise specified, the time period used for calculations involving GWP is 100 years. Thus, the GWP for methane (CH₄) determined on a 100-year time horizon is 23 (i.e., one metric ton of methane emitted into the atmosphere is equivalent to 23 metric tons of carbon dioxide emission). GHG conversion facility 100 may include, among other things, a GHG collection apparatus 111, a GHG conversion apparatus 112, a product collection apparatus 113, a reactant storage apparatus 115, and one or more sensing devices 116a-c.

GHG collection apparatus 111 may include a variety of technologies for receiving, collecting, storing, and/or extracting GHG for use in a GHG conversion process. GHG collection apparatus 111 may include any component and/or system appropriate for the collection of GHG, such as, for example, natural gas drilling equipment, storage tanks, pump or vacuum equipment, transmission and distribution equipment and facilities, piping, or any other suitable equipment for collecting GHG. GHG collection apparatus 111 may store the collected GHG in storage tanks or subterranean facilities for subsequent conversion and/or use as a renewable-energy source.

In one embodiment, GHG collection apparatus 111 may include a landfill gas capture device 111a configured to collect methane gas emitted from the landfill. According to another embodiment, GHG collection apparatus 111 may include an agricultural gas capture device 111b configured to collect methane gas emitted from agricultural sources. In another embodiment, GHG collection apparatus 111 may include a biomass capture device 111c configured to collect methane gas emitted from decaying vegetation, animal waste, and/or other source. In yet another embodiment, GHG collection apparatus 111 may include a coal bed methane capture device 111d configured to extract methane gas associated with coal bed seams in a mine environment. Although GHG collection apparatus 111 is described in one or more exemplary embodiments as being associated with methane gas collection, it is contemplated that GHG collection apparatus 111 may be associated with collecting any type of GHG that may be emitted into the atmosphere.

GHG converter 112 may include any device, apparatus, and/or process configured to convert a first GHG into a second GHG 114, wherein the second GHG 114 has a GWP less than that of the first GHG. GHG converter 112 may be configured to perform any type of GHG conversion process. For example, GHG converter may include an incinerator, wherein the methane is burned to produce carbon dioxide and heat. Alternatively GHG converter 112 may perform chemical conversion processes to convert the first GHG to the second GHG. For example, according to one embodiment, GHG converter 112 may include a water-gas reaction (also known as a steam reformation reaction) device that combines water, in the form of superheated steam with methane gas collected by GHG collection apparatus 111. According to this embodiment, the combination of water with methane induces the following chemical reaction:
CH₄(g)+H₂O(g)→3H₂+CO
The carbon monoxide can then be combined with superheated steam to induce the following chemical (e.g., water-gas shift) reaction:
CO(g)+H₂O(g)→H₂+CO₂.

As the above chemical conversion equations indicate, for a water-methane reaction, for every molecule of methane converted to carbon dioxide, four units of hydrogen gas are produced. In addition, the reaction reduces an estimated emission carbon dioxide equivalent (CO₂(e)) gas by 22 units (e.g., 23 CO₂(e) (methane)-1 CO₂(e) (carbon dioxide)=22 units of CO₂(e) reduced). Although one exemplary method for methane-to-hydrogen conversion process is disclosed, it is contemplated that additional and/or different methods for methane-hydrogen conversion may be employed and/or substituted. It is further contemplated that additional and/or different GHG may be substituted, and that the disclosed method for converting methane is exemplary only and not intended to be limiting.

Reactant storage apparatus 115 may include any device for storing, producing, and/or supplying one or more reactants to GHG converter 112 for use in one or more chemical conversion processes. As in the example above, reactant storage apparatus 115 may include a steam generation and storage facility for supplying superheated steam as the reactant in the methane-hydrogen conversion process. In certain combustion processes, such as methane combustion, reactant storage apparatus 115 may be unnecessary, as the reactant for combustion (oxygen gas) is readily available in the atmospheric air.

Product collection apparatus 113 may be operatively coupled to GHG converter 112 and configured to collect one or more conversion products associated with GHG converter 112. For example, product collection apparatus 113 may include one or more storage tanks, cooling devices, compressors, transport devices, or any other suitable device for storing one or more conversion products produced by GHG converter 112. These devices may include mobile or stationary devices that may be used to transport the conversion products to other locations (e.g., customer locations, storage facilities, etc.).

According to the exemplary methane-hydrogen capture and conversion process, product collection apparatus 113 may include compressors and cooling devices to convert gaseous hydrogen into liquid hydrogen for storage, sale, and/or transport. Product collection apparatus 113 may also include one or more transport tanks (or other fuel transmission devices) to transmit and/or distribute the hydrogen after processing.

Sensing devices 116a-c may include one or more components configured to gather data associated with one or more components and subsystems of system 100 and/or GHG conversion facility 110. For example, one or more sensing devices 116a-c may be operatively coupled to GHG collection apparatus 111, GHG converter 112, and product collection apparatus 113 to collect information associated with GHG conversion facility 110. This information may include, for example, an amount (e.g., volume, weight, mass, etc.), type, pressure, and temperature of GHG gas associated with the respective subsystem; a conversion rate or conversion amount associated with the conversion reaction; an impurity concentration associated with the GHG and/or conversion product; a flow rate of each of the one or more gases associated with the components and/or subsystems of system 100; a GHG concentration; or any other suitable information associated with GHG conversion facility 110. This information may be collected and stored by computer system 120 for analysis, storage, and/or further processing.

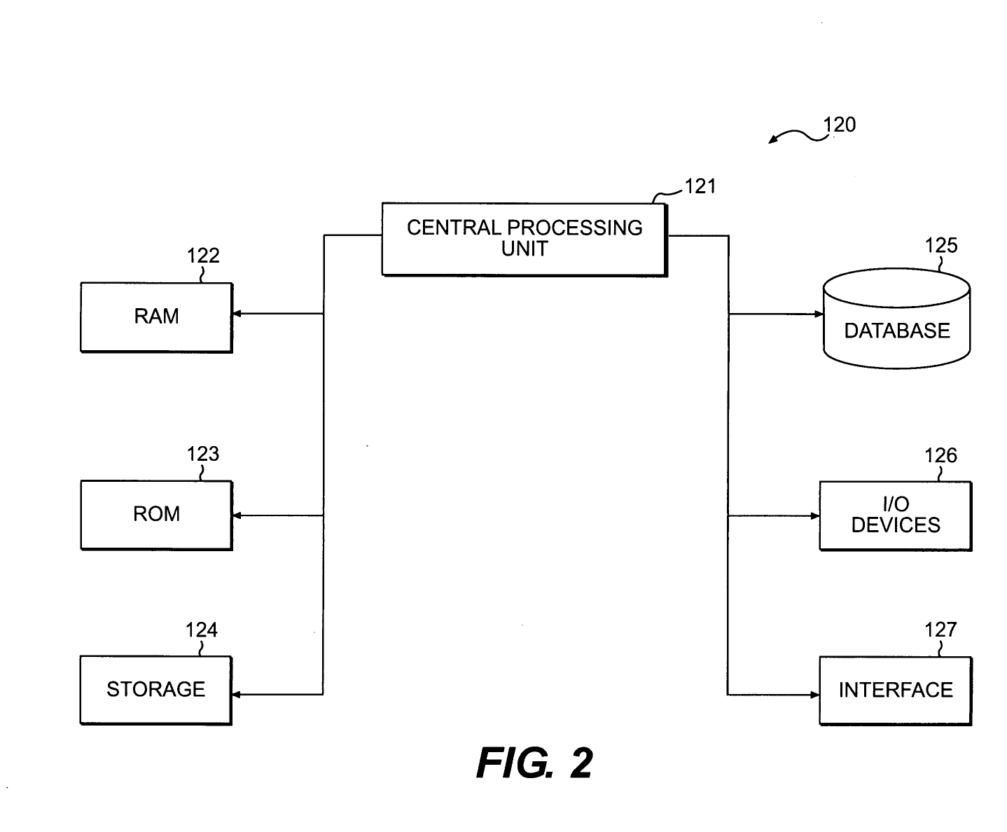

Computer system 120, as diagrammatically illustrated in FIG. 2, may include one or more hardware and/or software components configured to collect, monitor, store, analyze, evaluate, distribute, report, process, record, and/or sort information associated with system 100. For example, computer system 120 may include one or more hardware components such as, for example, a central processing unit (CPU) 121, a random access memory (RAM) module 122, a read-only memory (ROM) module 123, a storage 124, a database 125, one or more input/output (I/O) devices 126, and an interface 127. Alternatively and/or additionally, computer system 120 may include one or more software components such as, for example, a computer-readable medium including computer-executable instructions for performing a method associated with a GHG generation and utilization process. It is contemplated that one or more of the hardware components listed above may be implemented using software. For example, storage 124 may include a software partition associated with one or more other hardware components of computer system 120. Computer system 120 may include additional, fewer, and/or different components than those listed above. It is understood that the components listed above are exemplary only and not intended to be limiting.

Computer system 120 may be operatively coupled to sensing devices 116a-c and configured to receive information associated with system 100 and/or GHG conversion facility 110 that may be provided by sensing devices 116a-c. Computer system 120 may receive the information automatically (i.e., in real-time), as sensing devices 116a-c collect the information. Alternatively and/or additionally, computer system 120 may provide a data query to sensing devices 116a-c. Computer system 120 may receive information in response to the query. Computer system 120 may be configured to store, analyze, process, evaluate, and distribute information received from sensing devices 116a-c.

CPU 121 may include one or more processors, each configured to execute instructions and process data to perform one or more functions associated with computer system 120. As illustrated in FIG. 1, CPU 121 may be communicatively coupled to RAM 122, ROM 123, storage 124, database 125, I/O devices 126, and interface 127. CPU 121 may be configured to execute sequences of computer program instructions to perform various processes, which will be described in detail below. The computer program instructions may be loaded into RAM for execution by CPU 121.

RAM 122 and ROM 123 may each include one or more devices for storing information associated with an operation of computer system 120 and/or CPU 121. For example, ROM 123 may include a memory device configured to access and store information associated with computer system 120, including information for identifying, initializing, and monitoring the operation of one or more components and subsystems of computer system 120. RAM 122 may include a memory device for storing data associated with one or more operations of CPU 121. For example, ROM 123 may load instructions into RAM 122 for execution by CPU 121.

Storage 124 may include any type of mass storage device configured to store information that CPU 121 may need to perform processes consistent with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that cooperate to store, organize, sort, filter, and/or arrange data used by computer system 120 and/or CPU 121. For example, database 125 may store historical information such as price information associated with the sale or trade of GHG credits, price information associated with the sale of one or more conversion products (e.g., hydrogen, etc.), or any other information that may be used by CPU 121 to market and/or sell a conversion product and/or GHG credits associated with the conversion process. It is contemplated that database 125 may store additional and/or different information than that listed above.

I/O devices 126 may include one or more components configured to communicate information with a user associated with computer system 120. For example, I/O devices may include a console with an integrated keyboard and mouse to allow a user to input parameters associated with computer system 120. I/O devices 126 may also include a display including a graphical user interface (GUI) for outputting information on a monitor. I/O devices 126 may also include peripheral devices such as, for example, a printer for printing information associated with computer system 120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 127 may include one or more components configured to transmit and receive data via a communication network, such as the Internet, a local area network, a workstation peer-to-peer network, a direct link network, a wireless network, or any other suitable communication platform. For example, interface 127 may include one or more modulators, demodulators, multiplexers, demultiplexers, network communication devices, wireless devices, antennas, modems, and any other type of device configured to enable data communication via a communication network.

Optionally, computer system 120 may also be operatively coupled to a GHG validation system 130, as shown in FIG. 1, which may include one or more approved entities to evaluate and validate GHG credit generated by system 110. For example, computer system 120 may be communicatively coupled to GHG validation system 130 over the Internet via interface 127. Computer system 120 may format monitored data associated with the conversion process and submit required paperwork (either electronically or manually) for GHG credit validation to GHG validation system 130. Upon validation by the GHG validation system 130, GHG credits 132 may be issued.

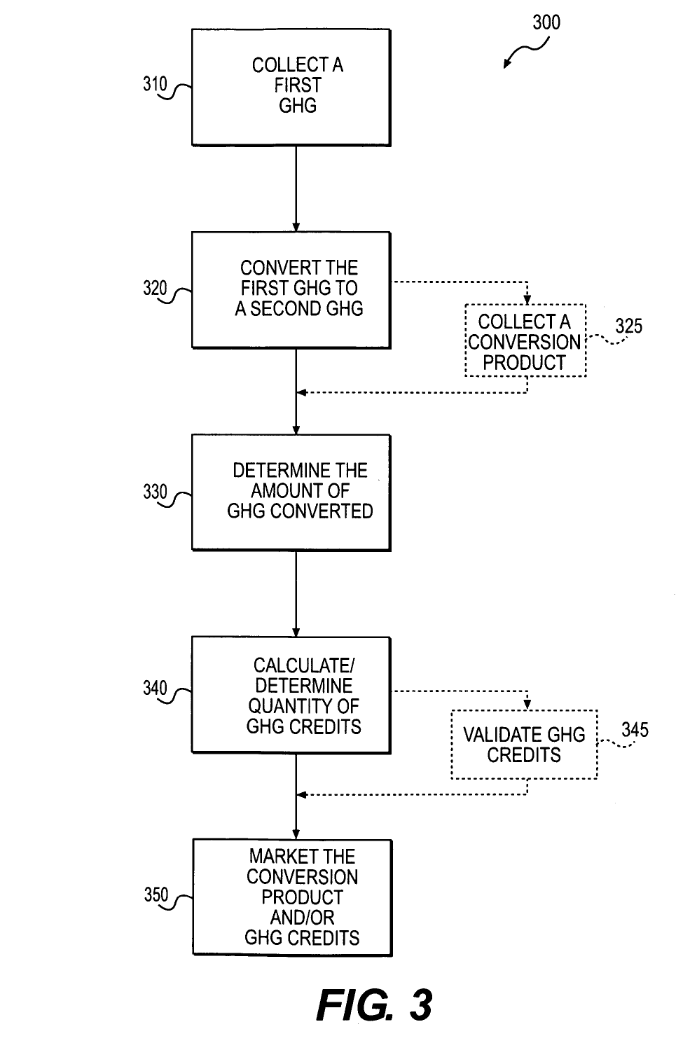

FIG. 3 provides a flowchart 300 illustrating an exemplary disclosed method associated with system 100 for generating and utilizing GHG credits, consistent with the disclosed embodiments. As illustrated in FIG. 3, the method may include collecting a first GHG (Step 310). For example, GHG collection apparatus 111 associated with system 100 may collect GHG (e.g., methane, etc.) from one or more GHG emission sources, such as a landfill, coal bed, biomass facility, or other source that emits GHG. Additionally, characteristics associated with the collection GHG may be monitored with sensors 116a-c.

Once the first GHG has been collected, the first GHG may be converted to a second GHG using one or more GHG conversion processes (Step 320). For example, system 100 may include GHG converter 112 configured to perform a conversion reaction, which converts the first GHG to a second GHG. This conversion process may include combining the GHG with one or more reactants, wherein the combination induces a chemical reaction that produces at least the second greenhouse gas and a conversion product (e.g., other gases, heat, water, etc.). For instance, in the methane-hydrogen conversion process as previously described, GHG converter 112 chemically combines water (in the form of steam) with methane, inducing a chemical reaction. This reaction may produce carbon monoxide and hydrogen, a potential alternative fuel for machines, vehicles, or other work implements.

The conversion process may also be eligible for GHG credits resulting from any reduction in the GWP of the emitted gas(es). In the case of the methane-hydrogen conversion process as previously discussed and according to one embodiment, methane (GWP of 23) is converted into CO₂ (GWP of 1), resulting in a 23 fold reduction in the amount of CO₂e emissions. Thus, credits corresponding to the GWP reduction may be received in exchange for the reduction.

In accordance with one embodiment, one or more conversion products and/or secondary GHG may be collected and/or stored for future use (Step 325). For example, product collection apparatus 113 may be coupled to an output of the GHG converter 112 to collect any products produced by the conversion process. These products may include the conversion products and the second GHG. Storing GHG conversion products may further reduce the CO₂e emissions (such as through the implementation of GHG sequestration techniques). The conversion products may be further converted into alternate products, treated prior to emission, processed into other usable materials, and/or sold. For example, in the methane-hydrogen conversion process, as previously described, carbon dioxide may be stored in a subterranean sink while the hydrogen may be collected and sold as fuel for hydrogen fuel-cell powered vehicles.

Once the GHG has been converted, an amount of a first GHG converted to a second GHG may be determined (Step 330). This determination may be based on, among other things, an amount of the first GHG consumed in the conversion process. For example, CPU 121 associated with system 120 may execute software that determines, based on information received from sensing devices 116a, a volume of a first GHG provided to GHG converter 112 by the GHG collection apparatus 111. Depending upon the percent yield of the particular conversion process used, the actual amount of GHG converted may be determined as:
GHG_{converted}=GHG_{supplied}×Yield_{process}.

As illustrated in this formula, the total GHG converted may be a function of the total GHG supplied to GHG converter 112, multiplied by the percent yield of the conversion process. For example, methane combustion has a theoretical yield of 98%. Thus for every 1 m³ of methane provided to a combustion process, only 0.98 m³ of methane is consumed by the process. For the methane-hydrogen conversion process (and certain other chemical conversion processes), methane consumption yields may reach 100%. As a result, all of the methane supplied to GHG converter 112 may be converted into CO₂ (and other products). Because different GHG may have different densities, system 100 may calculate a mass associated with the converted GHG using the ideal gas law.

Once an amount of the first GHG converted to the second GHG has been determined, a quantity of GHG credits may be determined (Step 340). This determination may be based on the mass of the first GHG converted into the second GHG and the GWP associated with each GHG. For example, system 100 may determine that, for every unit mass of methane (GWP of 23) converted into carbon dioxide (GWP of 1) by the methane-hydrogen conversion process, 22 GHG credits may be generated. In general, this conversion may be expressed as:
CO₂e Credits=m_{GHG converted}·(GWP_{GHG1}−GWP_{GHG2}),
where CO₂e Credits include the GHG credits generated by the conversion process, m_{GHG} converted includes the mass of the second GHG subtracted from the mass of the first GHG (measured/calculated in metric tons), and GWP_{GHG1} and GWP_{GHG2} include the GWP associated with the first and second GHGs, respectively.

In an optional step, once the quantity of GHG credits has been determined, the GHG credits may be validated (Step 345). For instance, system 100 may be configured to provide documentation (including conversion data, calculations, etc.) related to the conversion process and request validation for the determined amount of GHG credits. System 100 may be configured to provide this information automatically, via the Internet, to a GHG validation system 130. Alternatively and/or additionally, system 100 may be configured to complete the appropriate request forms for manual validation requests, and provide these forms to GHG validation system 130 or other suitable validation agent.

Upon determining a quantity of GHG credits, the conversion product and/or the GHG credits may be marketed, traded, distributed, and/or sold (Step 350). According to one embodiment, the GHG credits and conversion product(s) may be marketed and sold together, as part of a package. Alternatively, the GHG credits and conversion products may be sold separately. For example, hydrogen produced from the methane-hydrogen conversion process may be sold as fuel for hydrogen fuel-cell powered machines or vehicles, or for any other suitable use for hydrogen gas. The GHG credits may be sold and/or traded on one or more GHG trading markets to companies wishing to purchase the credits to reduce their balance of CO₂e emissions.

### INDUSTRIAL APPLICABILITY

Although the disclosed GHG generation and utilization system is described in connection with a GHG process that implements a methane capture and conversion process, it is contemplated that the disclosed system may be used with any GHG that may be converted to produce GHG credits. Additionally, any GHG conversion process may include any process suitable for converting one GHG to another GHG, resulting in the generation of GHG credits such as, for example, combustion, steam reformation (or other chemical conversion processes), oxidation, microwave radiation, or electrolysis.

The presently disclosed GHG generation and utilization system may have several advantages. For example, the presently disclosed system may provide a single system for generating, collecting, marketing, and selling both a conversion product and GHG credits associated with a GHG project. As a result, entities that rely on generating GHG credits to meet GHG reduction requirements may additionally benefit from the production and/or sale of products produced during the GHG credit generation process.

Additionally, certain embodiments may increase revenue associated with the generation and sale of GHG credits. For example, because the disclosed system can collect one or more conversion products associated with a GHG conversion process and market the conversion products in addition to the GHG credits, entities employing the disclosed system and method may realize an increase in revenue over systems that may be limited to selling GHG credits. This increased revenue may provide additional economic justification for an entity to engage in certain GHG emission reduction activities.

Further, certain embodiments associated with the disclosed system and method, particularly embodiments involving methane conversion processes, may require little or no resource (e.g., fuel) costs. As a result, the disclosed system may provide entities with a means for generating potentially profitable products, while potentially limiting material costs and reducing the amount of harmful GHG emitted into the atmosphere. For example, in certain disclosed embodiments, a system employing GHG conversion processes may utilize landfill and/or biomass methane capture devices, which collect GHG that would be otherwise freely emitted into the atmosphere. This methane may be combined with cheap and abundant reactants (e.g., water) to produce hydrogen gas, which may be sold as fuel for hydrogen fuel-cell-powered vehicles or for any other suitable use for hydrogen gas. Consequently, because the raw materials used for the conversion process may be inexpensive and readily available, costs associated with GHG collection and conversion may be easily controlled and minimized. This may reduce the overall costs associated with GHG credit and conversion product generation, potentially increasing the profitability of GHG conversion processes, while minimizing investment risk.

It will be apparent to those skilled in the art that various modifications and variations can be made to the disclosed GHG generation and utilization system and associated method without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for generating and utilizing greenhouse gas credits, comprising:
collecting a first greenhouse gas;
converting the first greenhouse gas to a second greenhouse gas to produce a conversion product, wherein the second greenhouse gas has a global warming potential less than a global warming potential associated with the first greenhouse gas;
determining a global warming potential reduction associated with the conversion;
determining a quantity of greenhouse gas credits associated with the conversion based on the global warming potential reduction; and
marketing one or more of the conversion product or the greenhouse gas credits associated with the conversion.

2. The method of claim 1, wherein collecting the first greenhouse gas includes collecting gaseous methane emitted from organic matter.

3. The method of claim 2, wherein converting the first greenhouse gas to a second greenhouse gas includes:
combining the methane with one or more reactants, wherein the combination induces a chemical reaction that produces at least one of the second greenhouse gas or the conversion product; and
collecting the conversion product produced by the conversion.

4. The method of claim 3, wherein one or more reactants includes water and the conversion product includes hydrogen.

5. The method of claim 1, wherein determining the global warming potential reduction includes:
determining an amount of the first greenhouse gas converted to the second greenhouse gas;
calculating the global warming potential reduction based on the determined amount of converted greenhouse gas.

6. The method of claim 1, wherein determining a quantity of greenhouse gas credits includes receiving validation of at least a portion of the determined quantity of greenhouse gas credits.

7. The method of claim 1, wherein marketing one or more of the conversion product or the greenhouse gas credits includes providing a purchase package including one or more of the conversion product or the greenhouse gas credits.

8. The method of claim 1, wherein marketing one or more of the conversion product or the greenhouse gas credits includes brokering the conversion product through a commodity market.

9. The method of claim 1, wherein marketing one or more of the conversion product or the greenhouse gas credits includes brokering the greenhouse gas credits through a greenhouse gas credit trading system.

10. A system for generating and utilizing greenhouse credits, comprising:
a greenhouse gas conversion facility including:
a greenhouse gas collection apparatus configured to store a supply of a first greenhouse gas;
a greenhouse gas converter, configured to convert the first greenhouse gas to a second greenhouse gas, wherein the second greenhouse gas has a global warming potential less than a global warming potential associated with the first greenhouse gas;
a product collection apparatus operatively coupled to the greenhouse gas converter and configured to store a supply of a conversion product; and
a computer system, in communication with the greenhouse gas conversion facility, configured to:
determine a global warming potential reduction associated with the conversion;
determine a quantity of greenhouse gas credits associated with the conversion based on the global warming potential reduction; and
market one or more of the conversion product or the greenhouse gas credits associated with the conversion.

11. The system of claim 10, the greenhouse gas collection apparatus is further configured to collect gaseous methane emitted from organic matter.

12. The system of claim 11, wherein the greenhouse gas converter is further configured to:
combine the methane with one or more reactants, wherein the combination induces a chemical reaction that produces at least the second greenhouse gas or the conversion product; and
provide the conversion product to the product collection apparatus.

13. The system of claim 12, wherein the one or more reactants includes water and the conversion product includes hydrogen.

14. The system of claim 10, wherein determining the global warming potential reduction includes:
determining an amount of the first greenhouse gas converted to the second greenhouse gas;
calculating the global warming potential reduction based on the amount of the first greenhouse gas converted to the second greenhouse gas.

15. The system of claim 10, wherein the system is further configured to receive validation of at least a portion of the determined quantity of greenhouse gas credits.

16. The system of claim 10, wherein the computer system is further configured to provide a purchase package including one or more of the conversion product or the greenhouse gas credits.

17. The system of claim 10, wherein the computer system is further configured to broker the conversion product through a commodity market.

18. The system of claim 10, wherein the computer system is further configured to broker the greenhouse gas credits through a greenhouse gas credit trading system.

19. The system of claim 10, wherein the greenhouse gas collection apparatus includes at least one of a landfill gas capture apparatus, an agricultural gas capture apparatus, a biomass gas capture apparatus, or a coal bed gas capture apparatus.

20. A computer system comprising:
one or more input devices configured to receive data associated with a greenhouse gas conversion facility from one or more sensing devices;
a central processing unit, communicatively coupled to the one or more input devices and configured to:
determine a global warming potential reduction associated with a greenhouse gas conversion, wherein a first greenhouse gas is converted to a second greenhouse gas, the second greenhouse gas having a global warming potential less than a global warming potential associated with the first greenhouse gas;
determine a quantity of greenhouse gas credits associated with the conversion based on the global warming potential reduction;
monitor an amount of a conversion product produced by the greenhouse gas conversion facility; and
market one or more of the conversion product or the greenhouse gas credits associated with the conversion.

21. The computer system of claim 20, wherein determining the global warming potential reduction includes:
determining an amount of a first greenhouse gas converted to a second greenhouse gas;
calculating the global warming potential reduction based on the amount of the first greenhouse gas converted to the second greenhouse gas.

22. The computer system of claim 20, wherein the system is communicatively coupled to a greenhouse gas validation system via an interface and further configured to receive validation of at least a portion of the determined quantity of greenhouse gas credits.

23. The computer system of claim 20, further configured to provide a transaction package including one or more of the conversion product or the greenhouse gas credits.

24. The computer system of claim 20, further configured to broker the conversion product through a commodity market.

25. The computer system of claim 20, further configured to broker the greenhouse gas credits through a greenhouse gas credit trading system.
